(19) United States
(12) Patent Application Publication
(10) Pub. No.: US 2007/0190860 A1
(43) Pub. Date: Aug. 16, 2007

(54) Plasma display apparatus

(75) Inventor: Yu Park, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/233,365

(22) Filed: Sep. 23, 2005

(30) Foreign Application Priority Data
Sep. 24, 2004 (KR) 2004-0077480
Jul. 21, 2005 (KR) 2005-0066480

(51) Int. Cl. H01R 13/66

(52) U.S. Cl. 439/620.06

(57) ABSTRACT

The present invention relates to a plasma display apparatus including a filter having an EMI film the entire area of which is patterned at a predetermined bias angle without a bare portion area. The EMI film is grounded through one or more connection members directly connected to the EMI film. Accordingly, a patterning process can be simplified using a single patterning mask regardless of the size of a panel. Furthermore, the EMI film of the filter and an AR film are formed on the same base film. Therefore, the manufacturing cost can be saved.

### BACKGROUND OF THE INVENTION

1. Field of the Invention

The present invention relates to a plasma display apparatus, and more particularly, to the construction of a filter attached to a panel, for shielding electromagnetic waves, and a connection structure between the filter and a panel

2. Background of the Related Art

In a plasma display apparatus, a discharge cell is formed between a rear substrate having barrier ribs formed therein and a front substrate opposite to the rear substrate. Vacuum ultraviolet rays, which are generated when an inert gas within each discharge cell is discharged with a high frequency voltage, light-emits phosphors, thus implementing images.

FIG. 1 shows the construction of a typical plasma display apparatus.

A panel 20 has a front substrate and a rear substrate, which are combined in parallel.

A casing 10 surrounding the panel 20 includes a front cabinet 11 and a rear cover 12. The plasma display apparatus further includes a printed circuit board 30 for driving the panel 20, a heat radiation plate 40 for radiating heat generated from the panel and the printed circuit board, and a filter 50 attached to a top surface of the panel.

The plasma display apparatus further includes a finger spring gasket 13 and a filter supporter 14, which support the filter 50 and electrically connect the rear cover 12. There is also provided a module supporter 15 for supporting a module in which the printed circuit board 30 and the panel 20 are combined.

Meanwhile, the filter 50 includes a glass filter 50a and a film filter 50b.

The conventional glass filter 50a includes an anti-reflection (AR) film 57 for preventing dazzling, a color-dye film 58 for shielding near infrared (NIR) and controlling the color, and an electromagnetic interference (EMI) film 59 for shielding electromagnetic waves, all of which are attached to a transparent glass substrate 56, as shown in FIG. 2.

The conventional film filter 50b includes a first base film 51, an EMI film 54 including a mesh portions 53 attached to the first base film and made of a conductive material having a mesh shape and a bare portion 52 formed at the edges of the mesh portions, a second base film 61, and an AR film 62 attached to the second base film, as shown in FIG. 3.

Furthermore, transparent resin 60 is filled between the mesh portions 53. The second base film 61 to which the AR film 62 is attached is adhered to the EMI film 54 by means of an adhesive 55.

Meanwhile, each of the EMI film 59 included in the glass filter 50a and the EMI film 54 included in the film filter 50b includes the mesh portions 53 in which a conductive material is formed in mesh form, and the bare portion 52, which is located at the outer edges of the mesh portions and is not patterned, as shown in FIG. 4.

Furthermore, the mesh portions 53 have a predetermined bias angle (θ) in order to prevent the Moire phenomenon in which circular or straight-line patterns appear with them being overlapped due to electrical interference of barrier ribs of the panel and the mesh portion when being combined with the panel.

However, not only the bias angle (θ) of the mesh portions 53 must be modified depending on the size of a panel in order to minimize the Moire phenomenon, but also the EMI film 54 must be fabricated separately depending on the size of a panel since the bare portion 52 is formed at the edges of the mesh portions 53. Accordingly, there are problems in that the manufacturing process of the film filter 50b is complicated and the cost is increased.

Furthermore, the film filter 50b according to the related art requires two sheets of the base films 51 and 61 so as to form the EMI film 54 and the AR film 62, respectively, as shown in FIG. 3. Accordingly, there are also problems in that the manufacturing process is complicated and the cost is increased.

### SUMMARY OF THE INVENTION

Accordingly, the present invention has been made in view of the above problems.

The present invention provides a filter including an EMI film having a mesh portion the entire area of which is patterned at a predetermined bias angle without a bare portion area. The present invention can simplify a patterning process of an EMI film using a single patterning mask regardless of the size of a panel since the EMI film is grounded through one or more connection members connected to a patterned portion of the EMI film.

The bias angle is an angle formed between the EMI film and a predetermined barrier rib, and is substantially the same over the entire area. Furthermore, the bias angle is a value, which can be variably set by a designer depending on the size of a panel, and can have an angle to minimize an EMI phenomenon generated between the EMI film and a predetermined barrier rib.

The EMI film is formed on a first base film. An AR film formed on the same line as the EMI film can be formed on a second base film.

Furthermore, according to the present invention, the EMI film and the AR film are formed on upper and lower surfaces of the same base film, respectively, and one or more connection members are connected to a patterned portion of the EMI film. It is thus possible to simplify a process of a film included in the filter.

The filter further includes at least one or more of an optical characteristic film and a NIR EMI film. The EMI film can shield NIR emitted from the panel.

The panel coupled to such a filter includes a ground portion made of conductive metal at the edges in such a way as to be electrically connected to the connection members. The ground portion is formed outside an active area on which images are displayed and is electrically connected to a rear cover surrounding the panel. At this time, to the ground portion can be attached a conductive tape.

### BRIEF DESCRIPTION OF THE DRAWINGS

Further objects and advantages of the invention can be more fully understood from the following detailed description taken in conjunction with the accompanying drawings in which:

FIG. 1 shows the construction of a typical plasma display apparatus;

FIG. 2 is a sectional view of a conventional glass filter;

FIG. 3 is a sectional view of a conventional film filter;

FIG. 4 is a perspective view illustrating an EMI film of the conventional film filter;

FIG. 5 is a first perspective view illustrating an EMI film constituting a film filter according to the present invention;

FIG. 6 is a sectional view of a film filter according to a first embodiment of according to the present invention;

FIG. 7 is a sectional view of a film filter according to a second embodiment of according to the present invention;

FIG. 8 is a second perspective view illustrating an EMI film constituting a film filter according to the present invention;

FIG. 9 is a sectional view of a film filter according to a third embodiment of according to the present invention;

FIG. 10 is a perspective view illustrating a first embodiment of a panel module to which the filter of the present invention is adhered;

FIG. 11 is a sectional view illustrating a first embodiment of a panel module to which the filter of the present invention is adhered;

FIG. 12 is a perspective view illustrating a second embodiment of a panel module to which the filter of the present invention is adhered;

FIG. 13 is a sectional view illustrating a second embodiment of a panel module to which the filter of the present invention is adhered;

FIG. 14 is a perspective view illustrating a third embodiment of a panel module to which the filter of the present invention is adhered;

FIG. 15 is a sectional view illustrating a third embodiment of a panel module to which the filter of the present invention is adhered;

FIG. 16 is a perspective view illustrating a fourth embodiment of a panel module to which the filter of the present invention is adhered; and

FIG. 17 is a sectional view illustrating a fourth embodiment of a panel module to which the filter of the present invention is adhered.

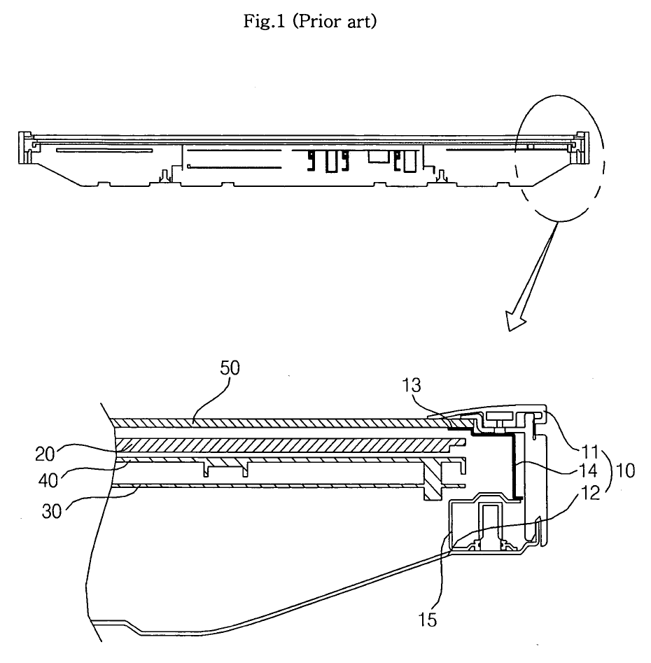

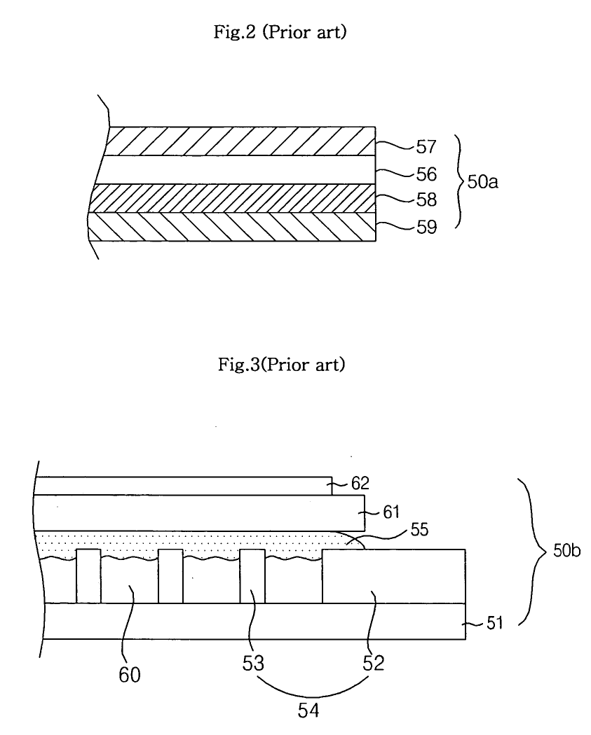

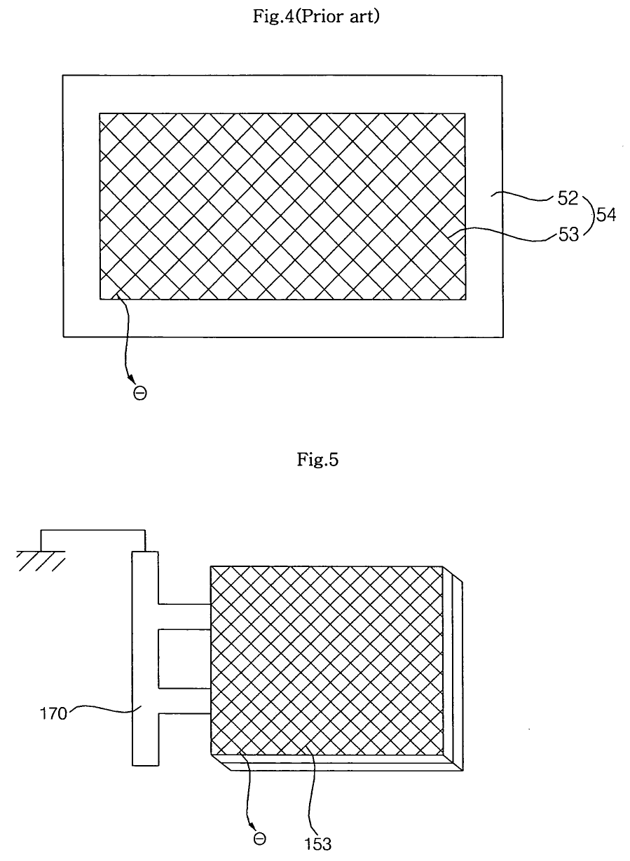

### DETAILED DESCRIPTION OF THE PREFERRED EMBODIMENT

A filter according to the present invention and a plasma display apparatus using the same will now be described in detail in connection with embodiments with reference to the accompanying drawings.

An embodiment of a plasma display apparatus according to the present invention may be plural. Hereinafter, the most preferred embodiment will be described. However, the basic structure of the plasma display apparatus will be replaced with that in the prior art.

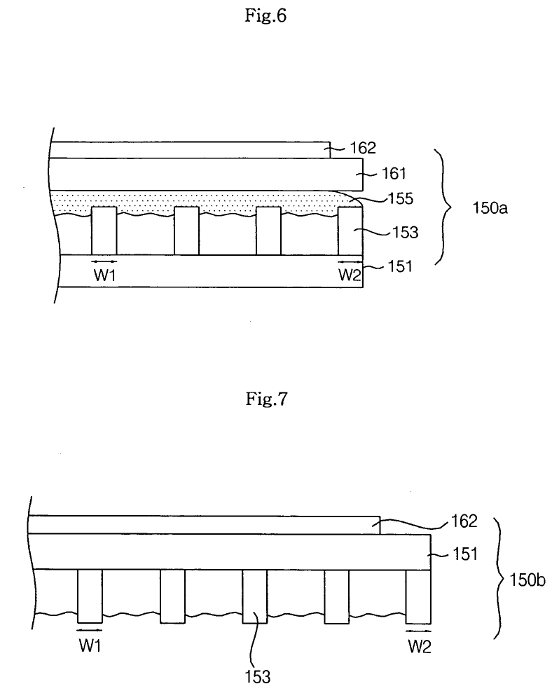

FIG. 5 is a first perspective view illustrating an EMI film constituting a film filter according to the present invention. FIG. 6 is a sectional view of a film filter according to a first embodiment of according to the present invention. FIG. 7 is a sectional view of a film filter according to a second embodiment of according to the present invention.

Referring to FIG. 5, an EMI film 153 according to the present invention has the entire area patterned at a predetermined bias angle (θ) without a bare portion and is formed using copper components. Furthermore, the EMI film 153 is ground through one or more connection members 170 directly connected thereto.

The EMI film 153 consists of only a mesh portion that is patterned to have a predetermined bias angle (θ) in order to prevent the Moire phenomenon. The mesh portion is patterned to have substantially the same bias angle over the entire area including the bare portion in the conventional filter.

The bias angle (θ) is an angle formed between the EMI film 153 and a predetermined barrier rib and can be set differently depending on the size of a panel. That is, the bias angle is preferably set to minimize the EMI phenomenon generated between the EMI film and a predetermined barrier rib since it is related to the EMI phenomenon.

Furthermore, the connection members 170 that are grounded are directly connected to the EMI film 153. The term “direct” connection refers to that the connection members 170 are directly connected to the patterned mesh portion of the EMI film 153 unlike the structure of the conventional filter, wherein electromagnetic waves flowing through the mesh are grounded through the bare portion.

These connection members 170 are formed using at least one of copper, gold and aluminum and are thus employed as a ground passage of electromagnetic waves.

As described above, the film filter according to the present invention includes the EMI films 153, which is patterned as a mesh having a predetermined bias angle (θ) even up to the area that was the conventional bare portion. Thus, after the mesh is formed only with a single patterning mask, it can be cut to have different bias angles depending on the size of a panel.

The sectional view of the film filter 150a according to the first embodiment will be described with reference to FIG. 6. The film filter 150a includes a first base film 151, EMI films 153 the entire area of which is patterned as a mesh, wherein the EMI films are attached to the first base film, a second base film 161, and an AR film 162 attached to the second base film.

Furthermore, transparent resin is filled between the meshes of the EMI films 153. The second base film 161 having the AR film 162 formed thereon is adhered to the EMI films 153 by means of an adhesive 155.

FIG. 7 is a sectional view of the film filter 150b according to the second embodiment. The film filter 150b includes a single base film 151, an AR film 162 formed on a display side of the base film, for preventing light incident on the panel from reflection, and EMI films 153 the entire area of which is patterned as a mesh having a predetermined bias angle, wherein the EMI films are formed on a panel side of the base film.

That is, the EMI films 153 constituting the film filter 150b of the second embodiment and the AR film 162 laminated on the same line as the EMI films 153 are formed on upper and lower surfaces of the same base film 151, respectively. This is simpler than the manufacturing process of the film filter 150a according to the first embodiment, in which the EMI film and the AR film are formed in two sheets of the base films, respectively. Accordingly, this results in a cost-saving effect.

The filters 150a and 150b constructed above according to the first embodiment and the second embodiment includes the EMI films 153 the entire area of which is patterned without the bare portion, wherein a width W1 at a central portion is the same as a width W2 at the boundary portion.

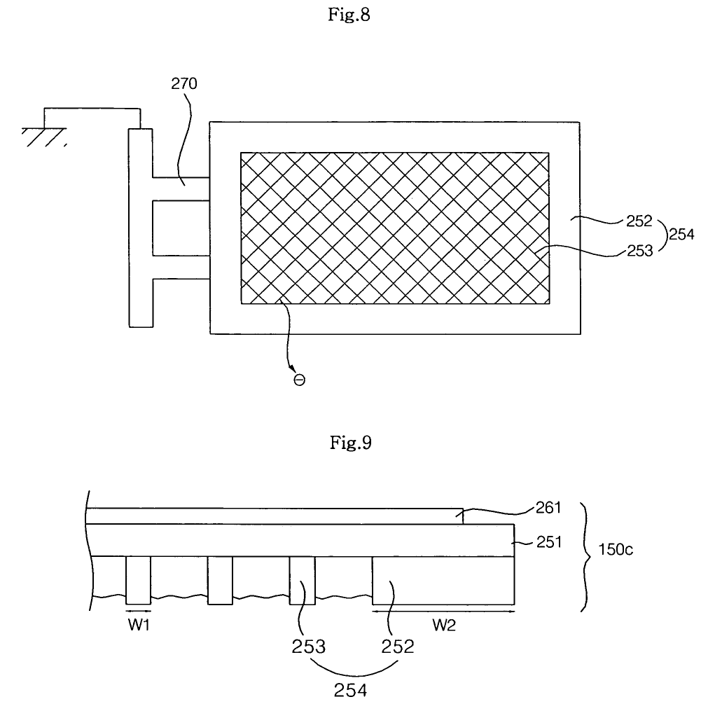

FIGS. 8 and 9 show the construction of a film filter according to a third embodiment of according to the present invention. An EMI film 254 shown in FIG. 8 is formed using copper components, and includes a mesh portion 253 patterned at a predetermined bias angle (θ) and a bare portion 252 surrounding the mesh portion. Furthermore, the EMI film 254 is ground through one or more connection members 270 connected to the bare portion 252.

The sectional view of a film filter 150c according to the third embodiment will be described with reference to FIG. 9. The film filter 150c includes a single base film 251, an AR film 261 formed on a display side of the base film, for preventing light incident on the panel from reflecting, and an EMI film 254, which is formed on a panel side of the base film and includes the bare portion 252 and the mesh portion 253 shown in FIG. 8.

That is, in the EMI film 254 of the filter 150c according to the third embodiment, a width W1 of the mesh portion 253 is different from a width W2 of the bare portion 252. The width W2 of the bare portion 252 can be greater than the width W1 of the mesh portion 253 such that a contact area between the EMI film 254 and the connection members 270 connected to the ground at the boundary portion of the filter is widened.

The filters 150a, 150b and 150c constructed above according to the first to third embodiments can further include at least one or more of an optical characteristic film (not shown) for improving an optical characteristic by controlling a color temperature of light incident from the panel and a NIR EMI film (not shown) for shielding NIR, as well as the EMI film and the AR film. Furthermore, the EMI film or the AR film according to the present invention can have a NIR-prevention function.

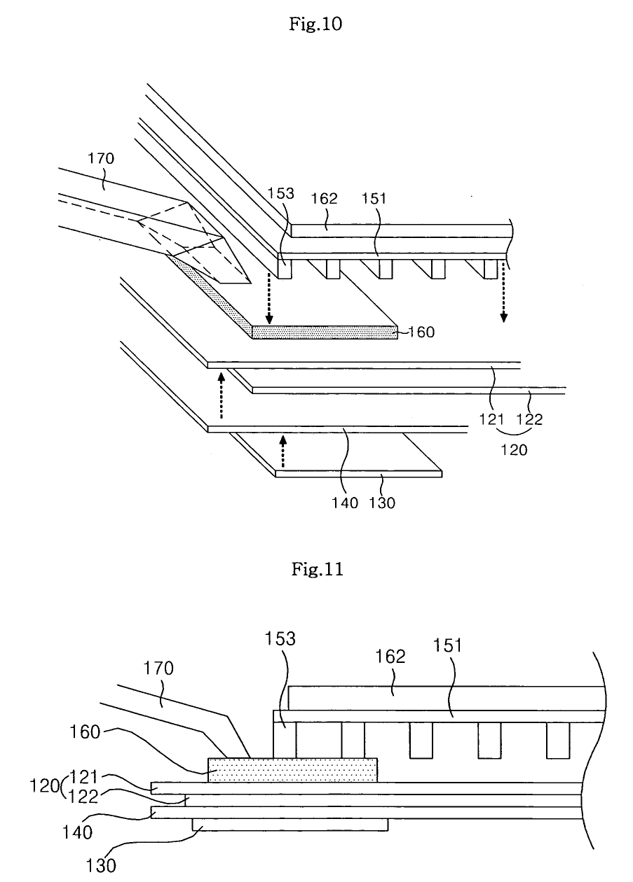

Hereinafter, FIGS. 10 to 17 show first to fourth embodiments of a module structure in which a filter is adhered to a panel. FIGS. 10 to 13 show the module structure to which the filter 150b of the second embodiment is adhered, and FIGS. 14 to 17 show the module structure to which the filter 150c of the third embodiment is adhered.

FIG. 10 is a perspective view illustrating the first embodiment of the panel module to which the filter of the present invention is adhered. FIG. 11 is a sectional view illustrating the first embodiment of the panel module to which the filter of the present invention is adhered.

A panel 120 has a front substrate 121 and a rear substrate 122, which are combined in parallel, and has a ground portion 160 formed thereon. The ground portion 160 is connected to a connection member 170 connected to the patterned portion of the filter according to the second embodiment shown in FIG. 7.

On a rear surface of the panel is adhered a printed circuit board 130 and a heat radiation plate 140 for radiating heat generated from the panel.

At this time, the ground portion 160 is made of conductive metal at the edges of the panel. The ground portion 160 is brought in contact with EMI films 153 the entire areas of which are patterned and are connected to a rear cover (not shown) through the connection member 170. The panel edge refers to the outer block of an active area on which images are displayed.

The printed circuit board 130 adhered to the heat radiation plate 140 is a driving circuit substrate for supplying a driving signal to electrodes of the panel. The panel 120 displays a predetermined image in response to the driving signal.

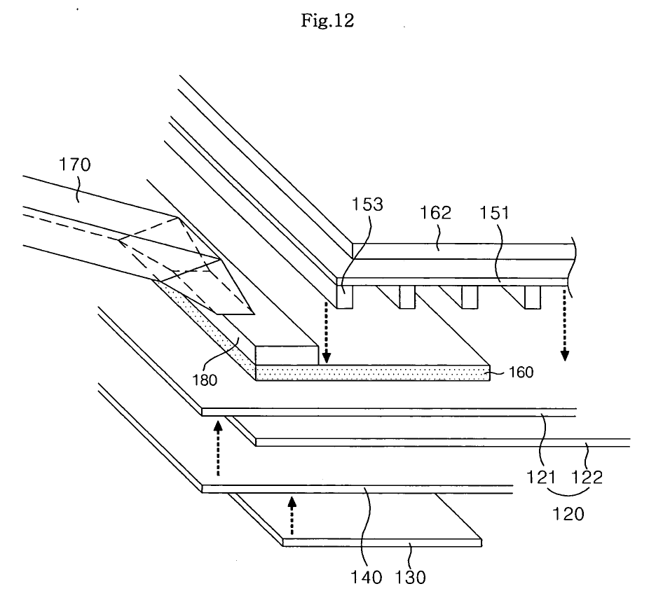

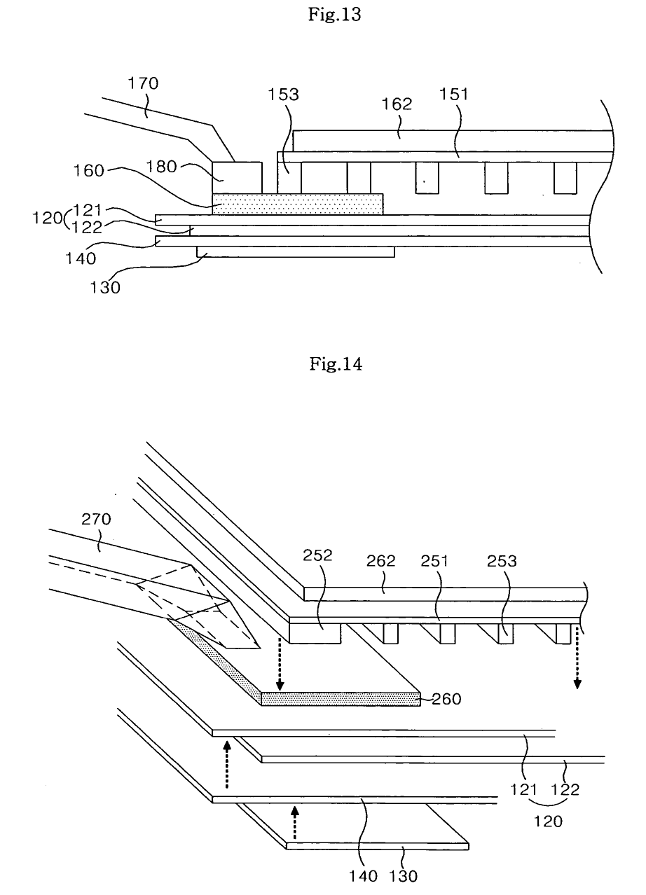

Furthermore, FIG. 12 is a perspective view illustrating a second embodiment of a module structure. FIG. 13 is a sectional view illustrating a second embodiment of a module structure.

In the present embodiment, the structure including a panel 120, a filter having EMI films 153 the entire areas of which are patterned, a ground portion 160 made of conductive metal at the edges of the panel and connected to a patterned portion of the EMI film, a connection member 170 connected to the ground portion, a printed circuit board 130 and a heat radiation plate 140 is the same as that of the embodiments shown in FIGS. 10 and 11.

However, the ground portion 160 of the second embodiment can further include a conductive tape 180. That is, the EMI film 153 the entire area of which is patterned is connected to the ground portion 160. The ground portion is connected to the connection member 170 through the conductive tape 180 and is connected to a rear cover (not shown).

Accordingly, the ground portion 160 can be formed at the outer block of the active area on which images are displayed. The conductive tape 180 is formed at the outer block of the ground portion and is brought in contact with the connection member 170.

If the connection member 170 made of metal is directly brought in contact with the ground portion 160 formed in the panel, it can apply physical force to the panel, resulting in a damaged panel. Thus, the conductive tape 180 functions to mitigate physical force generating when the connection member is directly brought in contact with the ground portion.

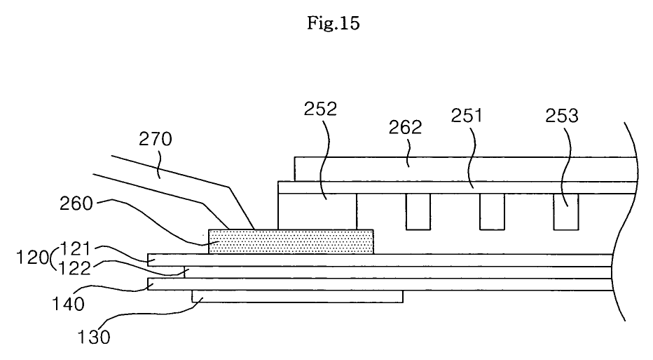

FIG. 14 is a perspective view illustrating a third embodiment of a module structure. FIG. 15 is a sectional view illustrating a third embodiment of a module structure.

A panel 120 has a front substrate 121 and a rear substrate 122, which are combined in parallel, and has a ground portion 260 formed thereon. The ground portion 260 is connected to the filter 150c of the third embodiment. The filter includes an EMI film having mesh portions 253 patterned at a predetermined bias angle and a bare portion 252 forming the edges of the mesh portions.

On a rear surface of the panel is adhered a printed circuit board 130 and a heat radiation plate 140 for radiating heat generated from the panel.

At this time, the ground portion 260 is made of conductive metal at the edges of the panel. The ground portion 260 is brought in contact with the bare portion 252 and is connected to a rear cover (not shown) through a connection member 270. The panel edge refers to the outer block of an active area on which images are displayed.

The printed circuit board 130 adhered to the heat radiation plate 140 is a driving circuit substrate for supplying a driving signal to electrodes of the panel. The panel 120 displays a predetermined image in response to the driving signal.

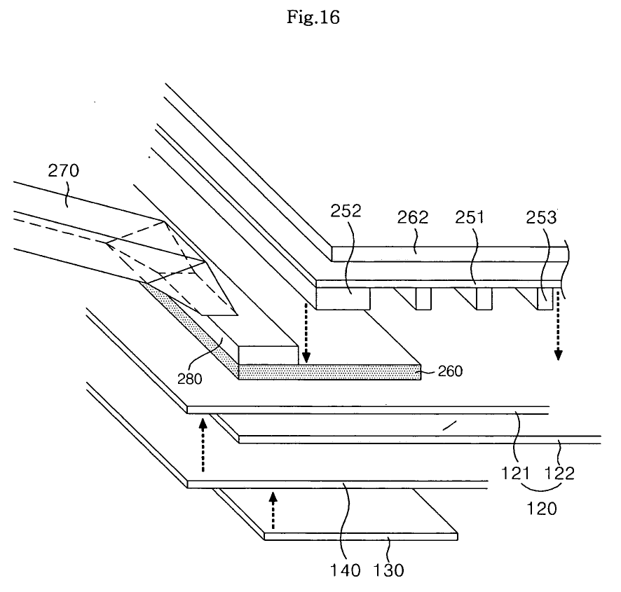

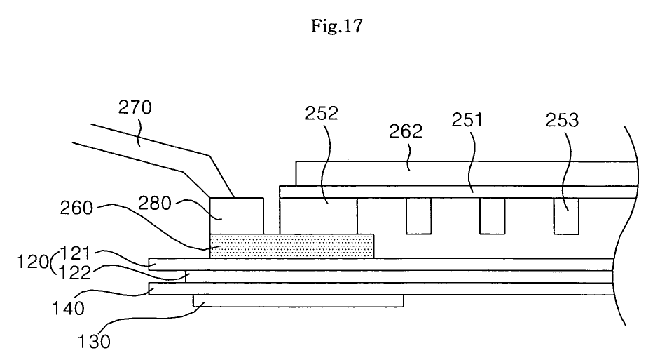

Furthermore, FIG. 16 is a perspective view illustrating a fourth embodiment of a module structure. FIG. 17 is a sectional view illustrating a fourth embodiment of a module structure.

In the present embodiment, the structure including a panel 120, a filter having an EMI film consisting of a mesh portion 253 and a bare portion 252, a ground portion 260 connected to the bare portion 252 of the EMI film, a connection member 270 connected to the ground portion, a printed circuit board 130 and a heat radiation plate 140 is the same as that of the embodiments shown in FIGS. 14 and 15.

However, the ground portion 260 of the fourth embodiment can further include a conductive tape 280. That is, the bare portion 252 of the EMI film is connected to the ground portion 260. The ground portion is connected to the connection member 270 through the conductive tape 280 and is connected to a rear cover (not shown).

Accordingly, the ground portion 260 can be formed at the outer block of the active area on which images are displayed. The conductive tape 280 is formed at the outer block of the ground portion and is brought in contact with the connection member 270.

If the connection member 270 made of metal is directly brought in contact with the ground portion 260 formed in the panel, it can apply physical force to the panel, resulting in a damaged panel. Thus, the conductive tape 280 of the fourth embodiment functions to mitigate physical force generating when the connection member is directly brought in contact with the ground portion.

As described in detail above, a plasma display apparatus according to the present invention includes a filter having an EMI film the entire area of which is patterned at a predetermined bias angle. Therefore, a single patterning mask can be employed regardless of the size of a panel and a bias angle. Furthermore, a panel according to the present invention is coupled to a filter in which an EMI film and an AR film are formed on the same base film. It is thus possible to simplify a fabrication process of a film included in the filter.

In the structure of a panel module to which this filter is adhered, a ground portion made of conductive metal is formed on one side of the panel and causes electromagnetic waves on the filter to flow to the ground through a connection member. A conductive tape is further included in the ground portion and thus mitigates shock given to the panel.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A plasma display apparatus, comprising:
a panel;
a filter including an electromagnetic interference (EMI) film patterned at a predetermined bias angle; and
one or more connection members connected to a patterned portion of the EMI film.

2. The plasma display apparatus as claimed in claim 1, wherein the EMI film has the entire area patterned.

3. The plasma display apparatus as claimed in claim 1, wherein the filter comprises at least one of an anti-reflection (AR) film, an optical characteristic film and a near infrared (NIR) EMI film.

4. The plasma display apparatus as claimed in claim 1, wherein the EMI film shields NIR emitted from the panel.

5. The plasma display apparatus as claimed in claim 1, wherein the bias angle is an angle formed between the EMI film and a barrier rib formed in the panel.

6. The plasma display apparatus as claimed in claim 1, wherein the bias angle is related to an EMI phenomenon generated between the EMI film and a barrier rib formed in the panel.

7. The plasma display apparatus as claimed in claim 1, wherein the EMI film is formed on a first base film, and an AR film laminated on the same line as the EMI film is formed on a second base film.

8. A plasma display apparatus, comprising:
a panel;
a filter in which an EMI film patterned at a predetermined bias angle and an AR film are formed on the same base; and
one or more connection members connected to a patterned portion of the EMI film.

9. The plasma display apparatus as claimed in claim 8, wherein the filter further comprises an optical characteristic film or a NIR EMI film.

10. The plasma display apparatus as claimed in claim 8, wherein the EMI film shields NIR emitted from the panel.

11. The plasma display apparatus as claimed in claim 8, wherein the panel or EMI film is electrically connected to the connection members, and a ground portion made of conductive metal is formed at the edge of the panel and is connected to the connection members.

12. The plasma display apparatus as claimed in claim 11, wherein the ground portion is formed outside an active area on which images are displayed.

13. The plasma display apparatus as claimed in claim 11, wherein the ground portion and the connection members are connected through a conductive tape.

14. The plasma display apparatus as claimed in claim 11, wherein the ground portion is electrically connected to a rear cover surrounding the panel.

15. A plasma display apparatus, comprising:
a panel;
a filter including an EMI film the entire area of which is patterned at a predetermined bias angle; and
one or more connection members connected to a patterned portion of the EMI film.

16. The plasma display apparatus as claimed in claim 15, wherein the predetermined bias angle is substantially the same in the entire area of the EMI film.

17. The plasma display apparatus as claimed in claim 15, wherein the EMI film is formed on a first base film, and an AR film laminated on the same line as the EMI film is formed on a second base film.

18. The plasma display apparatus as claimed in claim 15, wherein the EMI film and an AR film formed on the same line as the EMI film are formed on upper and lower surfaces of the same base film, respectively.

19. The plasma display apparatus as claimed in claim 15, wherein the EMI film includes copper components.

20. A plasma display apparatus, comprising:
a panel;
a filter in which an EMI film patterned at a predetermined bias angle and an AR film are formed on the same base film; and
one or more connection members connected to a non-patterned portion of the EMI film.
